(19) United States
(12) Patent Application Publication
(10) Pub. No.: US 2010/0303105 A1
(43) Pub. Date: Dec. 2, 2010

(54) GENERATING PULSE TRAINS IN Q-SWITCHED LASERS

(75) Inventors: Hagen Zimer, Jena (DE); Dietmar Kruse, Malans (CH)

Correspondence Address: FISH & RICHARDSON PC, P.O. BOX 1022, MINNEAPOLIS, MN, 55440-1022, US

(73) Assignee: TRUMPF LASER MARKING SYSTEMS AG, Grusch (CH)

(21) Appl. No.: 12/813,929

(22) Filed: Jun. 11, 2010

Related U.S. Application Data
(63) Continuation of application No. PCT/EP2008/008607, filed on Oct. 11, 2008.

(30) Foreign Application Priority Data
Dec. 13, 2007 (EP) 07024194.8

(51) Int. Cl. H01S 3/117

(52) U.S. Cl. 372/13; 372/25; 372/25

(57) ABSTRACT

The invention relates to methods and systems for generating a pulse train having several individual pulses, wherein the individual pulses have a desired pulse characteristic, by means of a Q-switched solid state laser system, which includes, e.g., a modulator for influencing the pulse characteristic of the individual pulses. The methods include (a) generating individual pulses of a pulse train, each pulse having a pulse characteristic, by applying a temporal initial modulation signal; (b) detecting the pulse characteristic of the individual pulses of the generated pulse train; (c) generating a modified modulation signal in correlation to the detected and the desired pulse characteristic of the individual pulses of the pulse train, and applying the modified modulation signal to the modulator to generate a pulse train with a modified pulse characteristic; (d) repeating step (c) until the modified pulse characteristic fulfills a predetermined termination criterion and then using the modified modulation signal as an optimum modulation signal; and (e) generating a pulse train with the desired pulse characteristic of the individual pulses thereof by applying the optimum modulation signal.

### CROSS-REFERENCE TO RELATED APPLICATIONS

This application is a continuation of and claims priority under 35 U.S.C. §120 to PCT/EP2008/008607, filed on Oct. 11, 2008, and designating the U.S., which claims priority under 35 U.S.C. §119 to European Patent Application No. 07024194.8, filed on Dec. 13, 2007. The contents of the prior applications are hereby incorporated by reference in their entirety.

### TECHNICAL FIELD

The present invention relates to methods for generating a pulse trains having several individual pulses by means of a Q-switched solid state laser, wherein the individual pulses have a desired pulse characteristic, and to Q-switched solid state laser systems that are suited to perform these methods.

### BACKGROUND

Pulsed, Q-switched solid state lasers are indispensable in many fields of laser material processing. A substantial component of processing systems of this type is the actual laser beam source, which consists of a resonator, a laser-active medium, and a Q switch. Host crystals (YAG, YVO₄, YLF) are used as laser-active media, which are doped with rare earth ions (Nd³⁺, Yb³⁺, Er³⁺). Such crystals are characterized by laser transitions that have a fluorescence lifetime of some ten microseconds up to a few milliseconds. For this reason, they are capable of storing the energy pumped into the laser medium during a low Q state in Q-switched laser resonators. This process is called inversion formation. During switching from a low to a high resonator Q factor, the inversion is suddenly dissipated and the stored energy is discharged in the form of a short pulse. Acousto-optical modulators (AOM) or electro-optical modulators (EOM) are generally used as Q-switches. The pulse energy and the pulse peak power depend on the amount of energy that was pumped into the laser medium during the low Q state, and thereby on the duration of the low Q state. The switching process of the resonator from a low to a high Q factor can be performed repetitively such that the laser emits a pulse train of short pulses (with pulse durations of a few nanoseconds up to a few microseconds) in correspondence with the switching frequency. The duration of the low Q state is constant between the individual pulses of the pulse train, for which reason the pulses have an almost identical energy and peak power. This, however, does not apply for the first pulse of the pulse train. Prior thereto, the laser resonator was in a low Q state for a considerably longer time, for which reason a considerably larger amount of energy was pumped into the laser-active medium. As a result thereof, the first pulse of a pulse train generally has a considerably higher energy and a considerably higher peak power than the subsequent pulses.

In particular, for laser marking with Q-switched solid state lasers, homogeneous pulses of the same pulse peak power and the same pulse energy are generally required for a good processing result. The marking pauses that occur, e.g., in vector marking, e.g., during transition from the end of a vector to the start of the next vector, require the laser to emit many time-limited pulse trains instead of one continuous pulse train. The excess of each of the first pulses of these pulse trains yields a clearly visible inhomogeneity of the marking in many marking applications.

There are already different conventional methods for preventing excess pulse energy or excess pulse peak power of the first pulse of a pulse train in Q-switched solid state lasers.

In one method, the Q-switch is not completely opened during emission of the first pulses. This method is described in more detail in U.S. Pat. No. 4,675,872. The first pulses of a pulse train are thereby weakened in a controlled fashion. This is achieved in that the Q-switch (AOM, EOM) is driven in such a fashion that it does not switch from a low Q state to a high Q state, but to medium Q states during these first pulses. In a medium Q state, a pulse is indeed generated, which has, however, a reduced pulse energy and pulse peak power as the resonator causes losses to the pulse due to the reduced Q factor (e.g., in the form of diffraction losses with AOM). With this method, it is generally not possible to sufficiently dissipate the excess energy stored in the laser crystal by the losses during emission of the first pulse only. In fact, part of the excess energy remains in the laser crystal, which necessitates weakening of further subsequent pulses. The pulse energy and the pulse peak power of the individual pulses thereby critically depend on the respectively set Q factor, which is predetermined, e.g., for the AOM by the amplitude of the RF power applied to the AOM. The corresponding control parameters of the Q switch, which generate optimum weakening of the first pulses, are not only laser-specific, but also depend on the working point (pumping power, repetition rate, pulse-pause ratio) of the laser. The determination of these control parameters is complex and problematic.

An alternative method is based on driving the pumping power prior to emission of the individual pulses in such a fashion that the pulses have the respectively desired pulse energy or pulse peak power. In this case, the effect of the change of the pumping power on the pulse energy and the pulse peak power also depends on the working point (pumping power, repetition rate, pulse-pause ratio) of the laser. The determination of suitable control parameters is also complex and problematic in this case.

In these conventional methods, the determination of the control parameters for the first pulse optimization is “quasi static,” i.e., these parameters are either fixed or are manually optimized by means of the marking result. Alternatively, a list of different parameter sets may be provided, from which the device software or the user selects the one that is best suited. The conventional methods are not satisfactory for the following reasons: First, the laser is operated during use at varying pumping powers, repetition rates and pulse-pause ratios such that frequent manual optimization is required or a very large number of parameter sets must be provided and the correct one must be selected. Second, the first pulse optimization may depend on the application such that a change of application requires manual optimization of the control parameters or provision of an even larger number of parameter sets. Third, the optimized parameter set is only valid for the state at the time of optimization. When the laser Q factor subsequently changes (deterioration of optics systems, degradation of the pump source, in case of the AOM degradation of the RF driver, etc.), the optimized parameters may possibly no longer be correct and require manual interaction. Fourth, the various parameter sets must generally be individually determined for each device, because the optimum parameter values may considerably differ between individual devices due to component scattering and adjustment deviations.

On the other hand, in certain cases it is desired for the first pulse or the first pulses not to have the same pulse energy or pulse peak power as subsequent pulses. For example, in vector marking, a lower pulse energy may be advantageous to compensate for the dynamic acceleration process of the mirror movement at the start of a vector.

### SUMMARY OF THE INVENTION

In contrast thereto, it is an object of the present invention to provide, inter alia, methods for generating a pulse train that has several individual pulses by means of a Q-switched solid state laser, wherein the individual pulses have desired pulse characteristics, in particular, wherein the first pulse(s) of the pulse train has/have a desired pulse energy or pulse peak power, and to provide a Q-switched solid state laser system that is suited to perform these methods.

This object is achieved in accordance with the invention by methods for generating a pulse train having several individual pulses, wherein the individual pulses have one or more desired pulse characteristics, by means of a Q-switched solid state laser that includes a modulator for influencing the pulse characteristic of the individual pulses. The new methods include (a) generating individual pulses of a pulse train, each pulse having a pulse characteristic, by applying a temporal initial modulation signal to the modulator; (b) detecting the pulse characteristic of all of the individual pulses of the generated pulse train; (c) generating a modified modulation signal altered in its modulation depth in correlation to the detected and the desired pulse characteristic of each of the individual pulses of the pulse train, and applying the modified modulation signal to the modulator to generate a pulse train with a modified pulse characteristic; (d) repeating step (c) until the modified pulse characteristic fulfills a predetermined termination criterion and then using the modified modulation signal as an optimum modulation signal; and (e) generating a pulse train with the desired pulse characteristic of the individual pulses thereof by applying the optimum modulation signal to the modulator.

In a further aspect, the invention also relates to systems for use with lasers, such as Q-switched solid state lasers, for generating a pulse train having several individual pulses, wherein the individual pulses have desired pulse characteristics. The systems include a modulator for influencing the pulse characteristics of the individual pulses; a detector for detecting the pulse characteristics of the individual pulses of a generated pulse train; a device connected to the detector and to the modulator that generates a modified modulation signal for driving the modulator on the basis of each of the detected and the desired pulse characteristic; and a data storage device in which the modified modulation signals are stored. The systems can also include the laser, e.g., a Q-switched solid state laser. The systems can also include an output device to display or print the detected pulse characteristic of the individual pulses of the generated pulse train to a user, as well as an input device that enables the user to modify the modulation signal.

Advantages of the invention can be extracted from the claims, the description, and the drawing. The features mentioned above and below may be used individually or collectively in arbitrary combinations. The embodiments shown and described are not to be understood as exhaustive enumeration but have exemplary character for.

### DESCRIPTION OF DRAWINGS

FIG. 1 is a schematic diagram that shows an embodiment of the inventive Q-switched solid state laser with first pulse modulation.

FIG. 2a is a graph that shows an initial pulse train consisting of several individual pulses with an excess first individual pulse, and the initial RF power pattern, on which this pulse train is based, of an acousto-optical Q switch shown in FIG. 1.

FIG. 2b is a graph that shows a pulse train that is first-pulse-modulated to alter the modulation depth of the pulse train shown in FIG. 2a, and the optimum RF power pattern, on which this modulated pulse train is based, of the acousto-optical Q switch.

### DETAILED DESCRIPTION

The invention provides new methods for generating pulse trains that have several individual pulses by means of a Q-switched solid state laser, wherein the individual pulses have desired pulse characteristics, in particular, wherein the first pulse(s) of the pulse train has/have desired pulse energies or pulse peak power. The invention also includes new systems for use with Q-switched solid state lasers that are suited to perform these methods.

The new methods enable the specific setting of the pulse energies or pulse peak powers of the first pulse(s). The new methods and systems not only simplify implementation of first pulse modulation in the production of Q-switched solid state lasers, but also allow first pulse modulation that is individually modulated to desired variable working points (pumping power, repetition rate, pulse-pause ratio). These methods also guarantee long-term reliability of first pulse modulation during application.

The modified modulation signal is generated fully automatically by means of an algorithm that is stored in a suitable control device or controller. For certain applications, it is advantageous for the first pulses of a pulse train not to have the same pulse energy as the subsequent pulses. It may be, e.g., desired to reduce the energy of the first pulse of a pulse train with respect to the subsequent pulses to compensate for the acceleration process of the scanner mirrors and the associated higher energy input per unit area. The user can predetermine this for the generating algorithm by means of corresponding scaling factors. It is thereby possible to predetermine either a time period and a common scaling factor or the number of pulses and a common scaling factor or separate scaling factors for individual pulses.

The desired pulse characteristics of the individual pulses may be, e.g., the pulse peak power or the pulse energy thereof. To thereby minimize the influence of fluctuations of the pulse peak powers or pulse energies that occur from pulse train to pulse train, several pulse trains are advantageously detected and a mean value is formed for each individual pulse of the pulse train to generate the modified modulation signal therefrom. The pulse characteristics can be detected directly or indirectly, e.g., by detecting the pulse duration, which gives information about the pulse energy or the pulse peak power.

The modulator in the new systems can act on the resonator Q factor or on the pumping power of the Q-switched solid state laser. By way of example, in a first case, the modulator may be the acousto-optical Q switch of a Q-switched solid state laser, which is driven by means of a temporal RF power modulation signal. When, e.g., the first pulse power is excessive, the RF power value per pulse is adjusted in dependence on the excess intensity in a “first initial attempt” such that the pulse peak powers or pulse energies become equal. Each pulse is given its own associated RF power value. This temporal RF power pattern is, in turn, transmitted to the Q switch, the pulse peak powers or pulse energies of the resulting pulse train are detected and processed by a control algorithm, and the temporal RF power pattern is modified again. This is repeated until the first pulse modulation is within parameters defined in that a predetermined termination criterion is fulfilled which may be, e.g., the maximum deviation of a pulse peak power or pulse energy from the mean value formed over all or a set of pulses or the maximum variance of the pulse peak powers or pulse energies of all or a set of pulses of the pulse train.

In one embodiment, prior to performing material processing with a pulse train having several individual pulses, the respective optimum modulation signal is determined for at least one working point of the solid state laser that occurs at a later time during material processing, in particular, for all working points that occur at a later time during laser processing. The solid state laser generates the suitable control parameters for first pulse modulation in a self-sufficient and adaptive fashion depending on its adjustment state or resonator Q factor, i.e., those control parameters that are instantaneously required for the actual processing (e.g., marking). Different algorithms can be applied for generating the modulation signal. One simple example is sequential modulation of the individual pulses. In a first step, the pulse peak power or pulse energy of the first pulse is appropriately adjusted to the mean value of the subsequent pulses through variation of the first modulation signal value or RF power value. Subsequently, the same process is performed for the second pulse by means of variation of the second modulation signal value and so on. This is terminated with the pulse that has a pulse peak power or pulse energy that does not substantially differ from the mean value of the subsequent pulses despite full modulation. As a further example, Hill Climbing algorithms or evolutionary algorithms may be used, e.g., genetic algorithms. In the latter case, initially random or also reasonably predetermined temporal modulation signal values or RF power patterns are sent to the AOM and the resulting pulse trains would be detected. A generating device, i.e., a control device or controller, selects the best modulation signal values or RF power patterns and then tries to modulate these to a desired level in an evolutionary fashion through iterative performance of the above-described process.

In one embodiment, the modulator is formed by a Q switch of the Q-switched solid state laser, in particular, by an AOM or EOM that influences the resonator Q factor of the Q-switched solid state laser in correspondence with the desired pulse characteristic of the individual pulses of the pulse train decoupled from the laser resonator. In another embodiment, the modulator is provided in the optical path of the pump light between a pump light source and a laser resonator of the Q-switched solid state laser and thereby acts on the pumping power of the Q-switched solid state laser. The modulator may alternatively also be the pump light source itself, the pumping power of which is modulated in correspondence with the desired pulse characteristic of the individual pulses of the pulse train decoupled from the laser resonator.

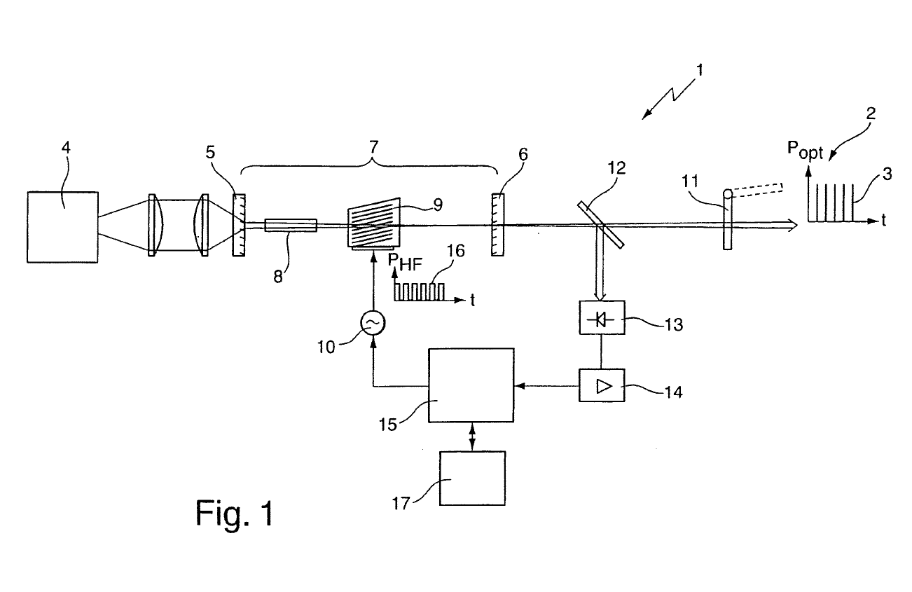

One example of a Q-switched solid state laser 1 is shown in FIG. 1. As shown in FIG. 1, the laser can be used to generate a pulse train 2 that includes several individual pulses 3 that each has, for example, a constant pulse energy. The solid state laser 1 comprises a pump source 4, a laser resonator 7 defined by a mirror 5, which is highly reflective to laser light, and a decoupling mirror 6, in which laser resonator a laser-active medium (laser medium) 8 pumped by the pump source 4 and an active Q switch in the form of an acousto-optical modulator (AOM) 9 are arranged, and also an RF driver 10 for driving the AOM 9. Host crystals (YAG, YVO₄, YLF, GdVO₄) which are doped with rare earth ions (Nd³⁺, Yb³⁺, Er³⁺) are used as laser medium 8. Such crystals are characterized by laser transitions that have a fluorescence lifetime of some ten microseconds up to a few milliseconds, and are therefore capable of storing the energy pumped into the laser medium 8 in the Q-switched laser resonator 7 during the low Q state. The pulse train 2 is decoupled from the laser resonator 7 via the decoupling mirror 6 and can be blocked or transmitted for processing by means of a shutter 11.

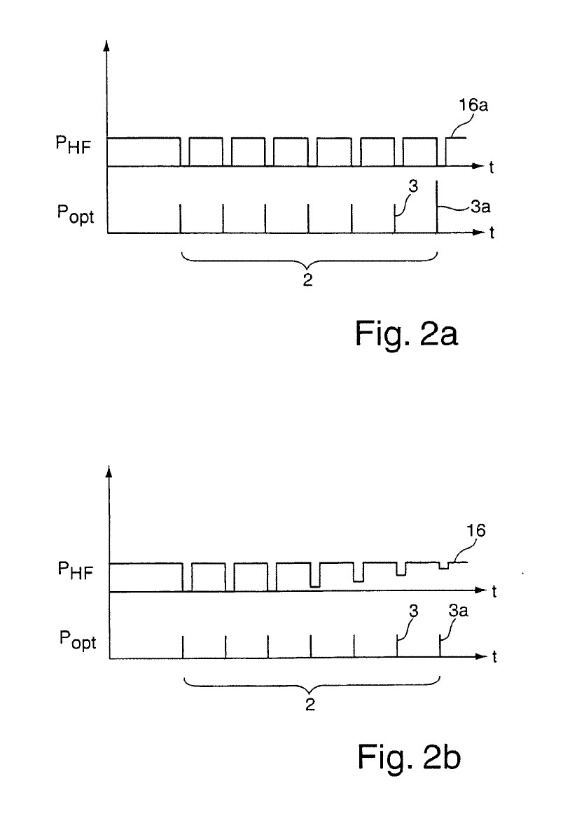

Prior to carrying out processing (e.g., marking), the solid state laser 1 is operated with closed shutter 11 at a working point (at a specific pumping power, repetition rate, and pulse pause ratio), which occurs or is expected to occur later during processing. The resonator Q factor is initially switched over with full modulation depth. This is realized in that the RF power that is output by the RF driver 10 and transferred to the AOM 9 is switched from its maximum value (low Q factor of the resonator) to zero (high Q factor of the resonator). FIG. 2a shows both the optical power Pₒₚₜ of the pulse train 2 consisting of several individual pulses 3 with a first individual pulse 3a that has an excessive power level and also the RF power P_{HF}, i.e., the initial RF power pattern 16a on which this pulse train is based, over time.

A small part (e.g., 4%) of the light emitted by the solid state laser 1 is directed via a beam divider 12 formed, for example, as a glass wedge, onto a detector 13 formed, for example, as a PIN photo diode. By means of a downstream “sample-and-hold” switch 14, the detector 13 detects the pulse peak powers of all individual pulses 3 of this pulse train 2. Alternatively, an integrator circuit may also be used to detect the pulse energies of all pulses of the pulse train. These detected values are then transferred to a control device 15 such as, e.g., a microcontroller. To minimize the influence of fluctuations of the pulse peak powers or pulse energies that occur from pulse train to pulse train, several pulse trains 2 are advantageously detected and a mean value is formed for each individual pulse of the pulse train 2. The control device 15 detects that the first individual pulse 3a of the pulse train 2 has an excessive power level and adjusts the RF power values to be applied to the AOM 9 for each individual pulse in dependence on the excess intensity in a “first attempt” such that the pulse peak powers or pulse energies assume identical values. The RF power is therefore no longer fully modulated during the first individual pulses. Each individual pulse 3 is given its individually allocated RF power value. This temporal modulation signal or RF power pattern 16 is then, in turn, applied to the AOM 9 via the driver 10, the pulse peak powers or pulse energies of the resulting pulse train 2 are detected and processed by the control device 15, and the temporal RF power pattern 16 is modified again.

This process is repeated until a desired first pulse modulation is obtained. The latter may be defined in that a predetermined termination criterion is met, which may be, e.g., the maximum deviation of a pulse peak power or pulse energy from the mean value formed over all pulses or the maximum variance of the pulse peak powers or pulse energies of all pulses of the pulse train. FIG. 2b shows the pulse train 2 which is first-pulse-modulated compared with the pulse train shown in FIG. 2a. In FIG. 2b all individual pulses 3, including pulse 3a, have the same pulse peak power (optical power Pₒₚₜ), and also shows the altered modulation depth of the desired RF power pattern 16 (RF power P_{HF}) of the AOM 9 on which this modulated pulse train is based. The desired RF power pattern 16 generated in this fashion is stored for the associated working point in a data storage device 17 connected to or within the control device 15. The same procedure is subsequently performed for all further working points that occur later during processing.

The shutter 11 is then opened for processing and a pulse train 2 with the desired pulse characteristic (e.g., first pulse weakening) is generated by applying the optimum modulation signal 16, which is stored for the desired pulse characteristics and the desired working point, to the AOM 9.

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. A method for generating a pulse train having several individual pulses, wherein the individual pulses have a desired pulse characteristic, by means of a Q-switched solid state laser which comprises a modulator for influencing the pulse characteristic of the individual pulses, the method comprising:
(a) generating individual pulses of a pulse train, each pulse having a pulse characteristic, by applying a temporal initial modulation signal to the modulator;
(b) detecting the pulse characteristic of all of the individual pulses of the generated pulse train;
(c) generating a modified modulation signal altered in its modulation depth in correlation to the detected and the desired pulse characteristic of each of the individual pulses of the pulse train, and applying the modified modulation signal to the modulator to generate a pulse train with a modified pulse characteristic;
(d) repeating step (c) until the modified pulse characteristic fulfills a predetermined termination criterion and then using the modified modulation signal as an optimum modulation signal; and
(e) generating a pulse train with the desired pulse characteristic of the individual pulses thereof by applying the optimum modulation signal to the modulator.

2. The method of claim 1, wherein the desired pulse characteristic of the individual pulses is the pulse peak power or the pulse energy thereof.

3. The method of claim 1, wherein the modified modulation signal is generated on the basis of several pulse trains.

4. The method of claim 1, wherein the modulator acts on the resonator Q factor or on the pumping power of the Q-switched solid state laser.

5. The method of claim 1, wherein prior to performing laser processing with a pulse train having several individual pulses, the respective optimum modulation signal is generated and stored for at least one working point of the solid state laser which occurs later during processing.

6. The method of claim 5, wherein the respective optimum modulation signal is generated and stored for all working points of the solid state laser which occur later during processing.

7. The method of claim 1, wherein the modified modulation signal is generated by means of sequential modulation of the individual pulses.

8. The method of claim 1, wherein the modified modulation signal is generated by means of an algorithm comprising one or more of an evolutionary algorithm, a genetic algorithm, or a Hill-Climbing algorithm.

9. The method of claim 1, wherein at least one optimum modulation signal is stored together with its associated working points.

10. A system for use with a Q-switched solid state laser for generating a pulse train having several individual pulses, wherein the individual pulses have a desired pulse characteristic, the system comprising:
a modulator for modulating the pulse characteristic of the individual pulses,
a detector for detecting the pulse characteristic of the individual pulses of a generated pulse train,
a control device connected to the detector and to the modulator and configured to generate a modified modulation signal altered in its modulation depth for driving the modulator in correlation to the detected and the desired pulse characteristic of each of the individual pulses in the pulse train, and
a data storage device in which the modified modulation signal is stored.

11. The system of claim 10, wherein the control device is further configured to apply the modified modulation signal to the modulator to generate a pulse train with a modified pulse characteristic; repeat the application of the modified modulation signal until the modified pulse characteristic fulfills a predetermined termination criterion and then use the modified modulation signal as an optimum modulation signal; and generate a pulse train with the desired pulse characteristic of the individual pulses thereof by applying the optimum modulation signal to the modulator.

12. The system of claim 10, further comprising a solid state Q-switched laser.

13. The system of claim 10, wherein, the detector is disposed in an optical path downstream of the modulator.

14. The system of claim 12, wherein the modulator is formed by a Q-switch of the Q-switched solid state laser.

15. The system of claim 12, wherein the modulator is provided in an optical path of the pump light between a pump light source and a laser resonator of the Q-switched solid state laser or is formed by the pump light source itself.

16. The system of claim 10, wherein at least one optimum modulation signal including an associated working point thereof is stored in the data storage device.
